(19) United States
(12) Patent Application Publication
(10) Pub. No.: US 2024/0253807 A1
(43) Pub. Date: Aug. 1, 2024

(54) LOAD-ALLEVIATION SYSTEMS FOR AIRCRAFT HAVING CENTRALLY STORED FUEL

(71) Applicant: The Boeing Company, Arlington, VA (US)

(72) Inventor: Thomas Skyler Sartorius, San Luis Obispo, CA (US)

(21) Appl. No.: 18/161,567

(22) Filed: Jan. 30, 2023

(51) Int. Cl. B64D 37/30; B64D 37/04; B64D 37/34

(52) U.S. Cl. CPC B64D 37/30; B64D 37/04; B64D 37/34

(57) ABSTRACT

An aircraft having a cryogenic and/or pressurized fuel stored in a generally central location has one or more integral wing tanks configured to store a nonfuel liquid. The weight of the liquid helps to alleviate load on the wing associated with the weight of the fuel in the fuselage. As the fuel in the fuselage is consumed, thus reducing the weight of the fuselage, the nonfuel liquid is selectively expelled and/or consumed so as to eliminate weight no longer needed to alleviate the load. In some examples, consuming the liquid includes injecting the liquid into a NOx-emitting turbine of the aircraft so as to reduce NOx emissions.

### FIELD

This disclosure relates to systems and methods for load alleviation in aircraft in which fuel is stored in a generally central area of the aircraft.

### INTRODUCTION

In many known aircraft, fuel is stored in integral tanks or other compartments in the wings. The weight of the fuel in the wings tends to relieve a bending moment on the wing root resulting from the weight of the fuselage and lift on the wings. However, certain fuel types are more easily stored in a central location of the aircraft (e.g., the fuselage) than the wing. For example, integral wing tanks may have too little volume to store an adequate amount of cryogenic and/or pressurized fuel because containers for these types of fuel generally require substantial thermal insulation and/or bulkier form factors (e.g., spheres, cylinders, and/or the like). Accordingly, alternative methods for relieving bending moment on the wing root have been developed. Known alternative methods have significant drawbacks, however. For instance, the wing can be strengthened by additional structural components, but this adds non-consumable weight to the aircraft. As another example, non-integral fuel containers (e.g., fuel pods) can be added to the wings to keep fuel mass located at the wings, but due to the form factor required for storing pressurized and/or cryogenic fuels, these fuel containers add a significant drag penalty. Better alternatives are needed for alleviating wing bending moment on aircraft with centrally stored fuel.

### SUMMARY

The present disclosure provides systems, apparatuses, and methods relating to load alleviation in aircraft having centrally stored fuel.

In some examples, a method for operating an aircraft using a cryogenic and/or pressurized fuel with reduced NOx emissions comprises: operating one or more engines of the aircraft using the fuel; and injecting a liquid comprising water into the one or more engines from a storage tank contained within a wing of the aircraft.

In some examples, an aircraft comprises: a fuselage; a wing extending from a lateral portion of the fuselage, the wing including a tank configured to store a liquid other than fuel; a turbine attached to the wing; an injection assembly configured to inject liquid from the tank into the turbine; and at least a first fuel container coupled to a fuel system configured to provide fuel from the at least first fuel container to the turbine, wherein the first fuel container is disposed inboard of the wing.

In some examples, an aircraft comprises: a fuselage; a wing attached to the fuselage; an engine attached to the wing; and a fuel tank disposed in the fuselage and in fluid communication with the engine; wherein the wing includes an integral interior compartment configured to contain a nonfuel liquid, and a liquid transfer assembly configured to selectively expel nonfuel liquid from the integral interior compartment.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative aircraft configured for load alleviation in accordance with aspects of the present teachings.

FIG. 2 is an isometric view of an illustrative airliner configured for load alleviation in accordance with aspects of the present teachings.

FIG. 3 is a sectional isometric view of an illustrative wing of an aircraft including a baffled integral tank for storing nonfuel liquid, in accordance with aspects of the present teachings.

FIG. 4 is a sectional top view of an illustrative wing of an aircraft having two spaced-apart integral tanks for storing nonfuel liquid(s), in accordance with aspects of the present teachings.

FIG. 5 is an isometric view of another illustrative aircraft configured for load alleviation in accordance with aspects of the present teachings.

FIG. 6 is a schematic diagram of an illustrative aircraft including a fuel cell, in accordance with aspects of the present teachings.

FIG. 7 is a flow chart depicting steps of an illustrative method for operating an aircraft with reduced NOx emissions according to the present teachings.

FIG. 8. is a flow chart depicting steps of an illustrative method for alleviating load on a wing of an aircraft according to the present teachings.

FIG. 9 is a flow chart depicting steps of an illustrative method for operating an aircraft according to the present teachings.

### DETAILED DESCRIPTION

Various aspects and examples of load-alleviating systems and/or devices for aircraft, as well as related methods, are described below and illustrated in the associated drawings. Unless otherwise specified, an aircraft in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Overview

In general, a method for alleviating aircraft load in accordance with aspects of the present teachings includes storing a nonfuel liquid in the wing(s) of an aircraft having centrally stored fuel, thereby alleviating load on the wing(s), and selectively expelling and/or consuming the nonfuel liquid as the amount of centrally stored fuel decreases. As the amount of centrally stored fuel decreases (e.g., through consumption by the propulsion system), the amount of mass needed in the wing to alleviate wing root bending moment decreases. Wing mass in excess of the needed amount thus offers no load alleviation benefits and has the detrimental effect of adding to the overall fuel consumption of the aircraft. Selectively expelling and/or consuming the nonfuel liquid in accordance with aspects of the present teachings reduces or eliminates the excess mass. This enables efficient operation of an aircraft that stores a significant amount of fuel in a central location, such as the fuselage, and allows the aircraft to carry a greater mass of cargo, passengers, and/or other suitable objects.

The nonfuel liquid can be expelled and/or consumed by any suitable process(es). In some examples, the liquid is simply ejected to an exterior environment of the aircraft (e.g., the air through which the aircraft is traveling). In some examples, the liquid is consumed by a suitable system and/or component of the aircraft. For example, some propulsion systems that use hydrogen fuel (e.g., hydrogen-burning turbines) produce high levels of nitrogen oxide emissions (also called NOx emissions) unless abated. Suitable abatement methods include injection of water. Accordingly, in some examples, methods of the present teachings include storing a liquid comprising water in the wing and, as centrally stored fuel is consumed, selectively injecting the liquid into a propulsion unit that would otherwise produce higher levels of NOx emissions. This has the effects of eliminating mass no longer needed to alleviate wing bending and also of abating NOx emissions. Additionally, in contrast to known systems, the need to carry the NOx-abating liquid in the aircraft does not simply impose unnecessary weight because the NOx-abating liquid serves the purpose of alleviating bending.

In general, systems and apparatuses of the present teachings include a container of an aircraft wing configured to hold a nonfuel liquid and one or more devices (e.g., pump(s), valve(s), and/or any other suitable device(s)) configured to remove liquid from the container. Removing liquid from the container may include causing and/or allowing the liquid to move to an exterior of the aircraft, to be injected into a propulsion unit and/or other suitable component of the aircraft configured to consume the liquid, and/or otherwise reducing the mass of liquid stored in the container. Removal of the liquid may be performed on demand and/or automatically, based on consumption of fuel stored at a generally central portion of the aircraft, a need for the liquid at another portion of the aircraft (e.g., a NOx-emitting turbine), and/or on any other suitable basis.

### Examples, Components, and Alternatives

The following sections describe selected aspects of illustrative systems and methods involving nonfuel liquid storage in aircraft wings for load alleviation and/or NOx emission reduction. The examples in these sections are intended for illustration and should not be interpreted as limiting the scope of the present disclosure. Each section may include one or more distinct embodiments or examples, and/or contextual or related information, function, and/or structure.

### A. Illustrative Aircraft

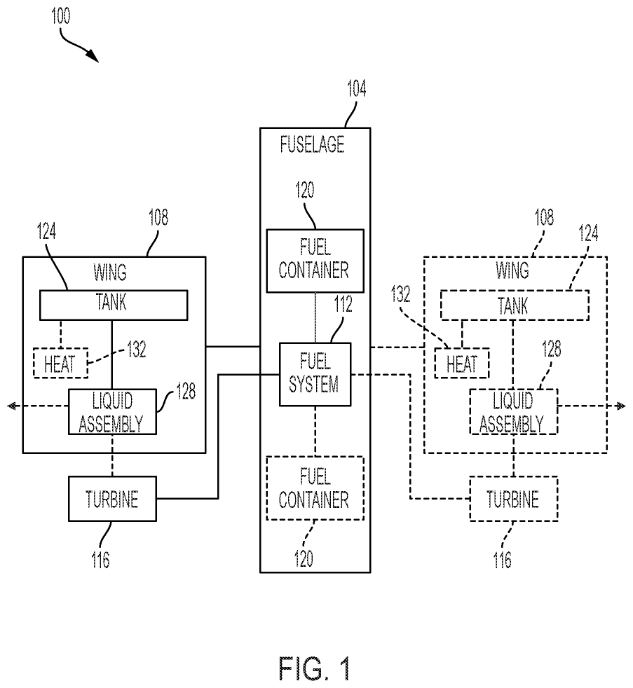

With reference to FIG. 1, this section describes an illustrative aircraft 100 having centrally stored fuel, one or more containers configured to store nonfuel liquid at wing(s) of the aircraft, and one or more assemblies configured to remove the nonfuel liquid from the container(s).

FIG. 1 is a schematic view of aircraft 100. As shown in FIG. 1, aircraft 100 includes a fuselage 104 and at least one wing 108 extending from the fuselage. Aircraft 100 may be any suitable now-known or later-developed aircraft for which it is desirable to relieve wing bending moment. For example, aircraft 100 may be a fixed wing aircraft such as an airliner. In some examples, aircraft 100 has a pair of wings 108 each extending from fuselage 104 (e.g., in opposing directions).

Aircraft 100 has a fuel system 112 configured to provide fuel to fuel-consuming component(s) of the aircraft, such as a turbine 116. Turbine 116 may also be referred to as an engine and in general may comprise any suitable propulsion device. Turbine 116 may be disposed on any suitable portion of aircraft 100, such as fuselage 104, wing 108, and/or any other suitable portion(s).

To fuel turbine 116, fuel system 112 draws fuel from at least one fuel container 120 configured to store fuel. Fuel container 120 is located at a generally central portion of the aircraft. For example, fuel container 120 may be disposed at least partially within the fuselage, and/or may be attached to the fuselage. In some examples, fuel container 120 is disposed at least partially inboard of the wing(s). In some examples, fuel container 120 is disposed at a root of one or more wings (e.g., adjacent a junction of the wing and the fuselage).

Fuel container 120 is configured to store a pressurized and/or cryogenic fuel under suitable conditions. For example, fuel container 120 may be configured to store a pressurized and/or cryogenic fuel such that the fuel is in a liquid phase during all or almost all expected operating conditions of the aircraft (including, e.g., temperature inside and/or outside the aircraft, pressure inside and/or outside the aircraft, and/or any other suitable factors). Storing the fuel in a liquid phase generally allows a greater mass of fuel to be stored in a given volume than would be possible by storing the fuel in a gas phase.

Being configured to store the fuel in a liquid phase may include being configured to store the fuel at a suitable pressure (e.g., comprising material(s) and shape(s) configured to resist rupture) and at a suitable temperature (e.g., being insulated and/or actively cooled by a cooling system). For cryogenic fuels, a suitable temperature is generally a cryogenic temperature, also called an ultra-cold temperature.

Fuel container 120 may have any suitable structure and composition for storing the fuel in question. For example, fuel container 120 may comprise a sphere, a cylinder, a capsule, and/or any other suitable shape(s). A composition of fuel container 120 may include metal, composites (e.g., carbon fiber composites), and/or any other suitable material(s). Without limitation, examples of fuel suitable for storage in fuel container 120 may include hydrogen, methane/natural gas, propane, butane, and/or ammonia.

In some examples, aircraft 100 includes at least two fuel containers 120, which may have the same or different capacities, form factors, and/or other characteristics. In some examples, the fuel containers are configured to store different types of fuel (i.e., the plurality of fuel containers are not all configured to store the same type of fuel).

In some cases, aircraft 100 may further include additional fuel containers other than fuel container(s) 120. In some examples, an additional fuel container is configured to store a conventional fuel such as jet fuel. In some examples, an additional fuel container is configured to store a cryogenic and/or pressurized fuel, which may or may not be the same type of fuel as the fuel stored in fuel container(s) 120. In some examples, additional fuel containers are disposed at a non-central portion of the aircraft, such as the wings.

In some examples, no fuel of any type is stored in the wing(s) of the aircraft. That is, in such examples, the aircraft wing(s) are free of any devices configured to hold fuel for storage, such that fuel is never present in the wings, or is present in the wings only at propulsion unit(s) disposed on the wings or when being conveyed toward such propulsion unit(s). In other examples, the wing(s) do include one or more fuel storage devices such as, e.g., integral fuel tanks (i.e., the wings are not entirely free of fuel storage), though a significant amount of fuel is stored in container(s) 120 at generally central portion(s) of the aircraft.

In some examples, aircraft 100 includes at least one fuel container configured to store jet fuel and at least one fuel container configured to store a pressurized and/or cryogenic fuel, such as liquid natural gas, and turbine 116 is configured to operate using either the jet fuel or the pressurized and/or cryogenic fuel.

Wing 108 includes at least one tank 124 configured to store a nonfuel liquid and at least one liquid transfer assembly 128 in fluid communication with the tank and configured to selectively cause and/or allow the nonfuel liquid to move to a suitable location. Liquid transfer assembly 128, which may also be referred to as an injection assembly, may include any suitable pump(s), valve(s), and/or other suitable devices configured to selectively cause and/or allow the movement of the nonfuel liquid out of the tank to the suitable location. Depending on the example in question, the suitable location may be an exterior of the aircraft (e.g., an ambient environment) and/or to turbine 116 (e.g., to a compressor of the turbine, to a combustor of the turbine, to a fuel line of the turbine, and/or to any other suitable portion(s) of the turbine). In some examples, liquid transfer assembly 128 is configured to selectively cause and/or allow the nonfuel liquid to move to one of a plurality of suitable locations, such as either to the environment or to the turbine.

In some examples, the liquid assembly is configured to disperse the liquid (and/or a product of the liquid, e.g., following any suitable processing) as an aerosol into the air, e.g., for geoengineering. Any suitable nonfuel liquid(s) may be used.

The nonfuel liquid may comprise any liquid(s) suitable for the example of aircraft 100 in question. In some examples, the nonfuel liquid comprises water. A nonfuel liquid comprising water may be suitable in examples in which the nonfuel liquid is injected into turbine 116 to reduce NOx emissions generated by the turbine. As another example, a nonfuel liquid comprising water may be suitable in examples in which the nonfuel liquid is ejected into the environment (e.g., due to the relatively low likelihood that the water will cause toxicity and/or other damage in the environment).

Whether or not the nonfuel liquid comprises water, the nonfuel liquid may optionally include one or more substances configured to adjust one or more characteristics of the liquid, such as a freezing point. For example, the nonfuel liquid may include one or more additives configured to prevent the liquid from freezing or boiling at expected operating conditions of the aircraft (including, e.g., expected temperatures and/or pressures based on expected altitudes, geographic locations, weather conditions, and/or the like). For example, an additive may be configured to lower a freezing temperature of the nonfuel liquid to a temperature below a freezing temperature of one or more other constituents of the nonfuel liquid (e.g., water). In some examples, tank 124 is insulated to help avoid freezing of the nonfuel liquid.

Tank 124 may comprise any suitable structure for storing the nonfuel liquid at the wing. For example, tank 124 may comprise any suitable components and/or materials for sealingly storing the nonfuel liquid, for insulating the nonfuel liquid, for resisting corrosion and/or rusting by the nonfuel liquid, for avoiding rupture by the nonfuel liquid, and/or any other suitable considerations.

In some examples, tank 124 is integral with the wing (e.g., disposed between unmodified top and bottom surfaces of the wing, in some examples similar to integral fuel tanks in “wet wing” aircraft). Compared to form factors that involve modifying the existing exterior profile of the wing, an integral tank does not impose a drag penalty on the aircraft. However, in some examples, tank 124 may be non-integral (e.g., attached to an exterior of the wing) and/or may otherwise extend beyond the typical profile of the wing in question because, e.g., of a desire to increase tank capacity despite a potential drag penalty, and/or in any other suitable circumstances.

In some examples, tank 124 is subdivided into two or more compartments by internal wall(s) and/or any other suitable devices. In some examples, wing 108 includes two or more tanks 124, which may be disposed and oriented in any suitable manner relative to each other. For example, two or more tanks 124 may be spaced from each other or disposed in contact with each other (e.g., with a wall of one tank contacting a wall of another tank, and/or with two or more tanks sharing a wall). In some examples, a wing includes a plurality of tanks in which a subset of tanks are spaced from each other and a subset are in contact with each other.

Tank 124 may include any suitable device(s) configured to reduce and/or mitigate the effect on aircraft control and/or aircraft balance of sloshing of nonfuel liquid in the tank. For example, tank 124 may include one or more baffles configured to limit, but not completely prevent, fluid flow between portions of the tank.

Optionally, one or more heat assemblies 132 may be disposed at wing 108 and configured to inhibit freezing of the nonfuel liquid. In some examples, heat assembly 132 comprises a heating device configured to generate heat to heat tank 124, such as one or more resistive heating elements, chemical heating elements, and/or the like. In some examples, heat assembly 132 comprises one or more device(s) configured to heat tank 124 using the heat of turbine 116. For example, heat assembly 132 may include a heat exchanger configured to warm nonfuel liquid by bringing at least a portion of the nonfuel liquid into proximity with turbine 116 and/or with oil drawn from the turbine's oil system.

### B. Illustrative Airliner

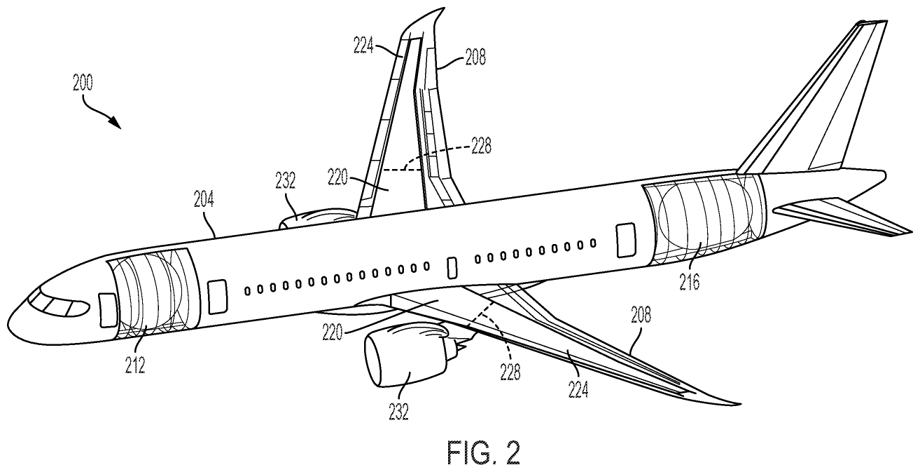

With reference to FIG. 2, this section describes an illustrative airliner 200 in accordance with aspects of the present teachings. Airliner 200 is an example of aircraft 100, described in Section A above. FIG. 2 is an isometric view of airliner 200 in which portions of the outer surface of the airliner are omitted to show the fuel containers described below.

Airliner 200 comprises a fuselage 204 configured to carry passengers and/or cargo. A pair of wings 208 extend laterally from opposing sides of fuselage 204.

A first fuel container 212 is disposed in a forward portion of fuselage 204, and a second fuel container 216 is disposed in an aft portion of the fuselage. In the depicted example, first fuel container 212 has a spherical shape and second container 216 has a cylindrical shape with hemispherical end portions (also known as a capsule or a stadium of revolution). These shapes are generally suitable for holding a pressurized and/or cryogenic liquid fuel. In other examples, however, fuel containers may have any other suitable shape. Fuel containers 212, 216 are examples of fuel containers configured to store fuel in a generally central portion of an aircraft, as described above.

Each wing 208 has a first integral tank 220 and a second integral tank 224 separated by a dividing wall 228. First and second integral tanks 220, 224 are configured to hold a liquid other than fuel. The liquid helps to reduce bending moment on the wing in which it is stored. As fuel in fuel containers 212, 216 is consumed, the effective mass of the fuselage decreases and less mass is needed in the wings to alleviate bending moment. Accordingly, a portion of the liquid stored in tanks 220, 224 is consumed by a system of the aircraft and/or expelled from the aircraft, thereby removing unneeded mass from the wing.

Dividing wall 228 may separate tanks 220, 224 in any suitable manner. For example, in some cases dividing wall 228 separates tanks 220, 224 without permitting fluid communication between them. In such cases, each tank 220, 224 is separately in fluid communication with an assembly configured to allow liquid from that tank to be expelled from the aircraft and/or moved to a system of the aircraft configured to consume the liquid. In some cases, however, dividing wall 228 impedes fluid communication between tanks 220, 224 without fully preventing fluid communication. This may, e.g., reduce sloshing while still allowing liquid to transfer from one tank to another. In some cases, dividing wall 228 has a valve or other suitable device(s) configured to selectively permit, enable, and/or enable while impeding to a selected degree, fluid communication between tanks 220, 224.

In the depicted example, each wing 208 has a pair of tanks 220, 224 divided by a single wall 228. In other examples, each wing may have any suitable number of tanks divided by any suitable numbers of walls. See, e.g., Sections C and D below.

A turbine 232 is attached to each wing 208. Turbines 232 are powered by fuel stored in fuel containers 212 and/or 216. In some examples, the liquid stored in tanks 220, 224 is suitable for injection into turbines 232 to reduce NOx emissions by the turbine. A liquid comprising water, optionally with additives configured to affect a freezing point and/or other suitable characteristics of the water, is an example of a suitable liquid for injection into a turbine.

### C. Illustrative Baffled Tanks

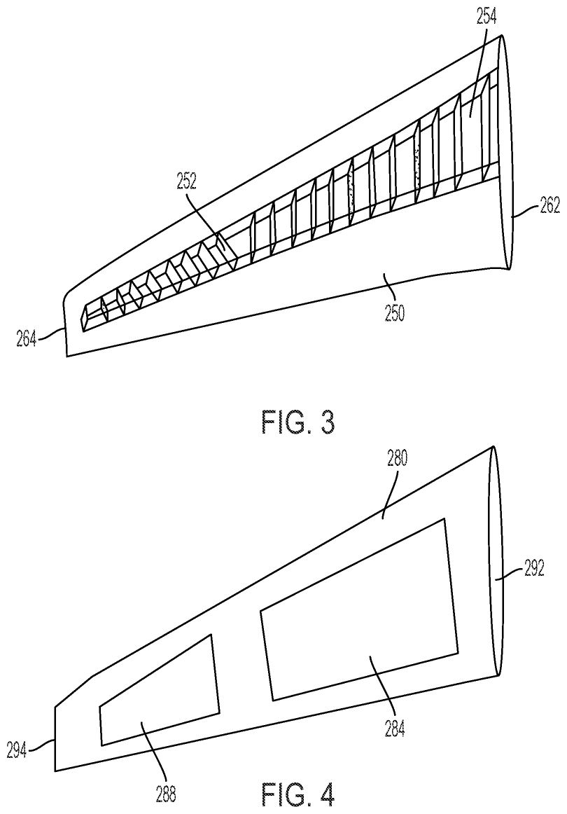

With reference to FIG. 3, this section describes an illustrative wing 250 including a baffled integral tank 254 for storage of a nonfuel liquid in accordance with aspects of the present teachings.

FIG. 3 is a top isometric sectional view of wing 250. Wing 250 extends from an inboard portion 262 of the wing (e.g., in the vicinity of a wing root of the wing) to an outboard portion 264 (e.g., a wing tip).

Wing 250 includes a tank 254, which is internal to wing 250 and can be described as an internal compartment of the wing and/or an integral tank. Tank 254 is configured to store a nonfuel liquid.

Tank 254 extends internally along wing 250 along the majority of the distance between inboard portion 262 and outboard portion 264 of the wing, at the interior of the wing. In other examples, the tank may extend along a minority of the distance, or half the distance.

Tank 254 includes a plurality of baffles 252 configured to inhibit sloshing of the liquid stored in the tank. In some examples, one or more of baffles 252 are part of another structural component of the wing, such as a wing rib, box beam, and/or the like.

### D. Illustrative Separate Tanks

With reference to FIG. 4, this section describes an illustrative wing 280 in accordance with aspects of the present teachings.

FIG. 4 is a top isometric sectional view of wing 280. Wing 280 extends from an inboard portion 292 of the wing (e.g., in the vicinity of a wing root of a wing) to an outboard portion 294 (e.g., a wing tip).

Wing 280 includes a pair of tanks 284 and 288. Each tank 284, 288 is internal to wing 280 and can be described as an internal compartment of the wing and/or an integral tank. Each tank 284, 288 is configured to store a nonfuel liquid. In some examples, the two tanks are configured to store different types of nonfuel liquid.

Each tank 284, 288 extends internally along an interior of wing 280. Tank 284 is disposed inboard relative to tank 288.

Tanks 284, 288 are spaced from each other in the interior of wing 280, such that tanks 284 and 288 are not in fluid communication with each other. Having two or more spaced-apart integral tanks in the wing may help reduce sloshing, facilitate storing two or more different types so nonfuel liquid in the wing, facilitate removal of liquid from a particular region of the wing before other particular regions of the wing, and/or facilitate a form factor for one or both tanks that is beneficial for storage of a particular type of nonfuel liquid (e.g., based on a type of thermal insulation, material strength, and/or other property suitable for a particular type of nonfuel liquid).

In some examples, one or both of tanks 284, 288 include baffles and/or other devices configured to reduce sloshing of liquid in the tanks. In some examples, more than two spaced-apart tanks are included in the wing.

### E. Illustrative Fuel Pods

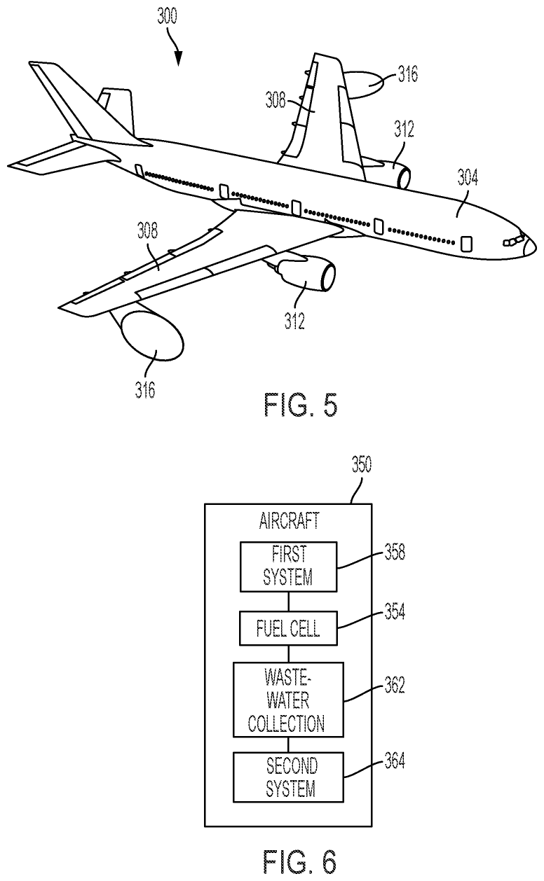

With reference to FIG. 5, this section describes an illustrative aircraft 300 in accordance with aspects of the present teachings. Aircraft 300 incorporates aspects of aircraft 100 and airliner 200, described above. As shown in FIG. 5, which is an isometric view of aircraft 300, aircraft 300 has a fuselage 304, a pair of wings 308 extending from the fuselage, and two turbines 312 each attached to a respective one of the wings. Wings 308 are each configured to hold a nonfuel liquid in one or more respective internal compartments and each wing includes one or more suitable liquid assemblies configured to facilitate transfer of the liquid from the internal compartment to one of the turbines, any other suitable system of the aircraft in which the liquid can be consumed, and/or an exterior of the aircraft.

Aircraft 300 further includes a pair of fuel pods 316 each attached to a respective wing 308 of the aircraft. Fuel pods 316 are configured to hold a suitable fuel for powering turbines 312. In some examples, the fuel of fuel pods 316 comprises a pressurized and/or cryogenic fuel.

In some examples, fuselage 304 includes one or more fuel storage devices configured to provide fuel for turbines 312, and fuel pods 316 provide backup and/or additional fuel for the turbines. The fuel stored in the fuselage and the fuel stored in fuel pods 316 may or may not be the same type of fuel. For example, fuel pods 316 may store a cryogenic and/or pressurized fuel and fuselage 304 may store a conventional jet fuel. In such an example, turbines 312 may be configured to run on the cryogenic and/or pressurized fuel and on the jet fuel (e.g., configured to selectively run on either type of fuel, or configured to run on a mixture of the types of fuel).

In some examples, fuel pods 316 store fuel used to power a system of the aircraft other than the turbines, such as a fuel cell.

In the depicted example, fuel pods 316 are disposed at outboard portions of wings 308, but in other examples, the fuel pods may be located at another suitable portion of the wing (e.g., adjacent the wing root, adjacent the turbine, etc.). Furthermore, in the depicted example the fuel pods extend from a bottom of the wings, but in other examples, the fuel pods may extend from a top or side (e.g., forward, aft, or outboard side) of the wings.

### F. Illustrative Aircraft Having a Fuel Cell

With reference to FIG. 6, this section describes an illustrative aircraft 350 in accordance with aspects of the present teachings.

FIG. 6 is a schematic diagram of aircraft 350. Aircraft 350 may comprise any suitable type of aircraft, such as a fixed-wing aircraft having a fuselage and at least one wing extending from the fuselage (see, e.g., fuselage 204 and wings 208 of airliner 200 in FIG. 2).

Aircraft 350 includes a fuel cell 354. Fuel cell 354 is configured to produce electricity to power a first system 358 of aircraft 350 using a suitable fuel, which in some examples comprises a cryogenic and/or pressurized fuel such as hydrogen.

As a byproduct of producing electricity, fuel cell 354 also produces water, also referred to in this context as wastewater. Aircraft 350 includes a wastewater collection system 362 configured to direct wastewater produced by fuel cell 354 to a second system 364 of the aircraft, which is configured to consume, use, and/or dispose of the wastewater.

For example, first system 358 may comprise any aircraft system suitable for running on, and/or receiving backup power from, the fuel cell in at least some conditions. In some examples, first system 358 is an auxiliary power unit (also called an APU) of aircraft 350. Second system 364 may comprise any system suitable for consuming, using, and/or disposing of the wastewater. In some examples, second system 364 comprises a turbine into which the wastewater can be injected to reduce NOx emissions by the turbine. In some examples, second system 364 is a water-cooling system of the aircraft configured to use liquid, including wastewater produced by fuel cell 354, to transfer heat. In such examples, the water-cooling system may be configured to cool an engine (e.g., a propulsion unit of the aircraft and/or any other suitable engine) and/or any other suitable device(s).

G. Illustrative Method for Operating an Aircraft with Reduced NOx Emissions

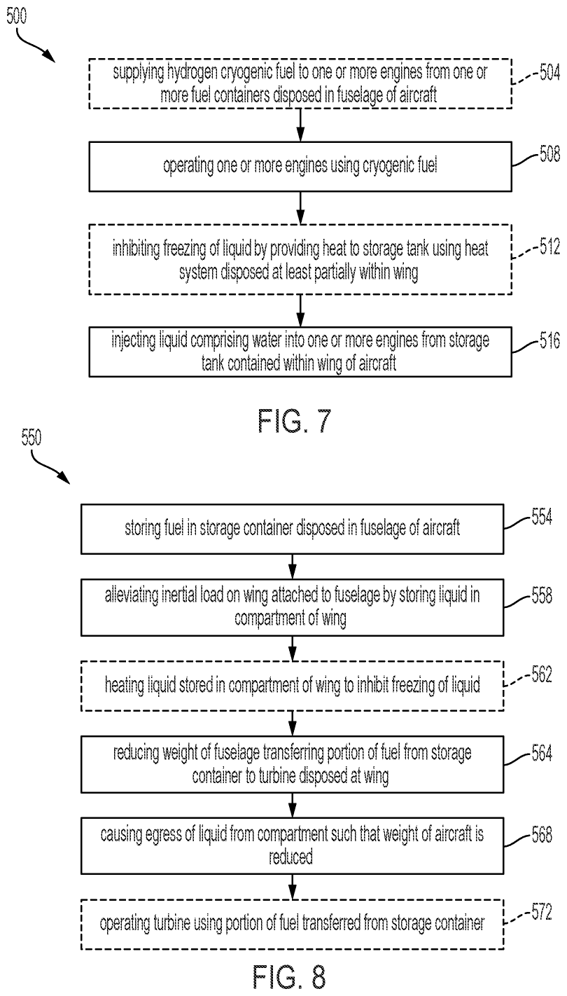

This section describes steps of an illustrative method 500 for operating an aircraft (e.g., aircraft 100) using a cryogenic and/or pressurized fuel with reduced NOx emissions; see FIG. 7. Aspects of aircraft described above may be utilized in the method steps described below. Where appropriate, reference may be made to components and systems that may be used in carrying out each step. These references are for illustration, and are not intended to limit the possible ways of carrying out any particular step of the method.

FIG. 7 is a flowchart illustrating steps performed in an illustrative method, and may not recite the complete process or all steps of the method. Although various steps of method 500 are described below and depicted in FIG. 7, the steps need not necessarily all be performed, and in some cases may be performed simultaneously or in a different order than the order shown.

At step 504, method 500 optionally includes supplying a cryogenic and/or pressurized fuel to one or more engines of an aircraft from one or more fuel containers disposed in a fuselage of the aircraft. In some examples, the one or more fuel containers include a first fuel container disposed in a first area of the fuselage and a second fuel container disposed in a second area of the fuselage, the first area being aft of the second area. In some examples, the cryogenic and/or pressurized fuel comprises one or more of the following: hydrogen, methane/natural gas, propane, butane, ammonia.

At step 508, method 500 includes operating the one or more of the engines of the aircraft using the cryogenic and/or pressurized fuel.

At step 512, method 500 optionally includes inhibiting freezing of a liquid disposed in a storage tank contained within a wing of the aircraft by providing heat to the storage tank. The liquid comprises water and optionally further comprises a substance configured to lower a freezing temperature of the liquid to a temperature below a freezing temperature of water. Providing heat to the storage tank includes using a heat system disposed at least partially within the wing. In some examples, the storage tank is incorporated integrally into an interior of the wing (e.g., it is an integral storage tank).

At step 516, method 500 includes injecting liquid from the storage tank of the wing into the one or more engines. Injecting the liquid comprising water into the one or more engines tends to reduce the amount of NOx emissions produced by the one or more engines. Accordingly, injection of the liquid tends to improve the environmental impact of the one or more engines. Additionally, the liquid injected into the one or more engines is at least partially consumed by the one or more engines and thus no longer contributes to the weight of the aircraft. This is particularly beneficial because, as the one or more engines consume the fuel stored in the fuselage, less weight is needed in the wing to mitigate bending moment on the wing associated at least in part with the weight of the fuselage. Consumption of the liquid stored in the wings by the one or more engines thus reduces or eliminates excess weight no longer needed to mitigate bending moment.

### H. Illustrative Method for Alleviating Load

This section describes steps of an illustrative method 550 for alleviating load on an aircraft, such as aircraft 100; see FIG. 8. Aspects of aircraft described above may be utilized in the method steps described below. Where appropriate, reference may be made to components and systems that may be used in carrying out each step. These references are for illustration, and are not intended to limit the possible ways of carrying out any particular step of the method.

FIG. 8 is a flowchart illustrating steps performed in an illustrative method, and may not recite the complete process or all steps of the method. Although various steps of method 550 are described below and depicted in FIG. 8, the steps need not necessarily all be performed, and in some cases may be performed simultaneously or in a different order than the order shown.

At step 554, method 550 includes storing fuel in a storage container disposed in a fuselage of an aircraft. The fuel comprises a non-inert cryogenic and/or pressurized fuel, such as one or more of the following: hydrogen, methane/natural gas, propane, butane, ammonia. In some examples, no fuel is stored in the wing of the aircraft (e.g., the fuel stored in the fuselage is the only fuel carried by the aircraft).

At step 558, method 550 includes alleviating an inertial load on a wing attached to the fuselage by storing a liquid in a compartment of the wing. The compartment may be an integral fuel tank. The liquid may be a liquid other than fuel and in some examples comprises water. Optionally, the liquid further may include an additive configured to prevent main constituents of the liquid (e.g., water in some cases) from freezing or boiling at expected operating conditions of the aircraft. The presence of the liquid in the wing alleviates load on the wing associated with the weight of the fuel stored in the fuselage.

At step 562, method 550 optionally includes heating the liquid stored in the compartment of the wing to inhibit freezing of the liquid.

At step 564, method 550 includes reducing a weight of the fuselage by transferring a portion of the fuel from the storage container to a turbine disposed at the wing. The turbine is configured to operate using the fuel (see step 572, below).

At step 568, method 550 includes causing egress of liquid from the compartment such that a weight of the aircraft is reduced. Step 568 may include causing the egress of the liquid based on (e.g., in response to) reduction of fuel mass stored at the fuselage. For example, a certain quantity of the liquid may be caused to exit the compartment based on a certain reduction in the amount of fuel stored at the fuselage. Causing egress of liquid from the compartment based on a reduction in centrally stored fuel may be performed automatically (e.g., by a computer controller of the aircraft, based on sensed data indicating the reduction in the fuel), partially automatically, and/or manually (e.g., by an operator of the aircraft observing and/or estimating the reduction in the fuel and causing egress of the liquid accordingly).

Causing egress of the liquid at step 568 may include ejecting the liquid from the compartment to an exterior of the wing and/or transferring the liquid from the compartment to a device of the aircraft that will consume or otherwise use the liquid. For example, step 568 may include injecting the liquid into the turbine to reduce NOx emissions by the turbine, which consumes the injected liquid. In such examples, the turbine may comprise a hydrogen-burning turbine and/or any other suitable turbine.

At step 572, method 550 optionally includes operating the turbine using the portion of the fuel transferred from the storage container.

### I. Illustrative Method for Operating an Aircraft

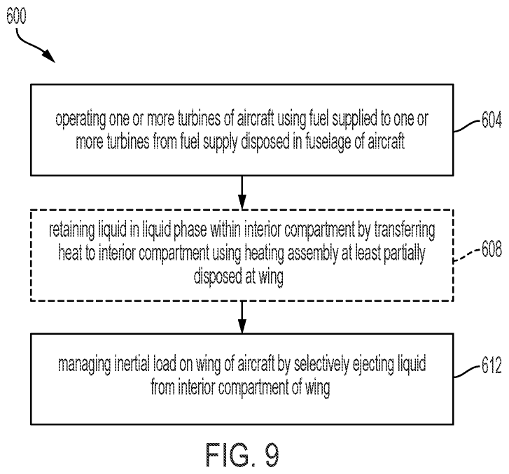

This section describes steps of an illustrative method 600 for operating an aircraft, such as aircraft 100; see FIG. 9. Aspects of aircraft described above may be utilized in the method steps described below. Where appropriate, reference may be made to components and systems that may be used in carrying out each step. These references are for illustration, and are not intended to limit the possible ways of carrying out any particular step of the method.

FIG. 9 is a flowchart illustrating steps performed in an illustrative method, and may not recite the complete process or all steps of the method. Although various steps of method 600 are described below and depicted in FIG. 9, the steps need not necessarily all be performed, and in some cases may be performed simultaneously or in a different order than the order shown.

At step 604, method 600 includes operating one or more turbines of an aircraft using a fuel supplied to the one or more turbines from a fuel supply disposed in a fuselage of the aircraft. The fuel may be a cryogenic and/or pressurized fuel comprising one or more of the following: hydrogen, methane/natural gas, propane, butane, ammonia.

At step 608, method 600 optionally includes retaining a liquid, which is disposed in a compartment of a wing of the aircraft, in a liquid phase within the compartment by transferring heat to the compartment. Transferring the heat to the compartment may include using a heating assembly at least partially disposed at the wing. For example, the heating assembly may include a heat exchanger configured to transfer heat from oil of the turbine to liquid from the compartment. In some examples, the liquid comprises water. In some examples, the compartment is an interior compartment formed integrally within the wing.

At step 612, method 600 includes managing inertial load on the wing of the aircraft by selectively ejecting liquid from the compartment of the wing. In some examples, selectively ejecting the liquid includes selectively injecting the liquid into at least one of the one or more turbines (e.g., to reduce NOx emissions by the turbine). In some examples, selectively ejecting the liquid includes selectively expelling the liquid to an exterior of the aircraft.

### J. Illustrative Combinations and Additional Examples

This section describes additional aspects and features of aircraft having nonfuel liquid stored in a wing for load alleviation, as well as associated methods, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations. Some of the paragraphs below include reference numerals referring to elements and/or method steps of disclosure from elsewhere in this application; these reference numerals are included below as illustrative non-limiting examples of subject matter described by the paragraph in question.
A1. A method (500) for operating an aircraft (100) using a cryogenic and/or pressurized fuel with reduced NOx emissions, the method (500) comprising:
operating (508) one or more engines (116) of the aircraft (100) using the cryogenic and/or pressurized fuel; and
injecting (516) a liquid comprising water into the one or more engines (116) from a storage tank (124) contained within a wing (108) of the aircraft (100).
A2. The method (500) of paragraph A1, further comprising supplying (504) the cryogenic and/or pressurized fuel to the one or more engines (116) from one or more fuel containers (120) disposed in a fuselage (104) of the aircraft (100).
A3. The method (500) of paragraph A2, wherein the one or more fuel containers (120) include a first fuel container (212) disposed in a first area of the fuselage (104) and a second fuel container (216) disposed in a second area of the fuselage (104), the first area being aft of the second area.
A4. The method (500) of any one of paragraphs A1-A3, wherein the storage tank (124) is incorporated integrally into an interior of the wing (108).
A5. The method (500) of any one of paragraphs A1-A4, further comprising inhibiting (512) freezing of the liquid by providing heat to the storage tank (124) using a heat system (132) disposed at least partially within the wing (108).
A6. The method (500) of any one of paragraphs A1-A5, wherein the liquid further comprises a substance configured to lower a freezing temperature of the liquid to a temperature below a freezing temperature of water.
A7. The method (500) of any one of paragraphs A1-A6, wherein the cryogenic and/or pressurized fuel comprises one or more of the following: hydrogen, methane/natural gas, propane, butane, ammonia.
A8. An aircraft (100) operated according to the method (500) of any one of paragraphs A1-A7.
B1. A method (550) for alleviating load on a wing (108) of an aircraft (100), the method (550) comprising:
storing (554) fuel in a storage container (120) disposed in a fuselage (104) of an aircraft (100);
alleviating (558) an inertial load on a wing attached to the fuselage (104) by storing a liquid in a compartment (124) of the wing (108);
reducing (564) a weight of the fuselage (104) by transferring a portion of the fuel from the storage container (120) to a turbine (116) disposed at the wing (108); and
causing (568) egress of liquid from the (124) compartment such that a weight of the aircraft (100) is reduced.
B2. The method (550) of paragraph B1, further comprising operating (572) the turbine (116) using the portion of the fuel transferred from the storage container (120).
B3. The method (550) of any one of paragraphs B1-B2, wherein causing (568) the egress of the liquid includes ejecting the liquid to an exterior of the wing (108).
B4. The method (550) of any one of paragraphs B1-B2, wherein the turbine (116) is a hydrogen-burning turbine, and causing (568) the egress of the liquid includes injecting the liquid into the turbine (116).
B5. The method (550) of any one of paragraphs B1-B4, wherein the liquid comprises water.
B6. The method (550) of paragraph B5, wherein the liquid further comprises an additive configured to prevent the water from freezing or boiling at expected operating conditions of the aircraft.
B7. The method (550) of any one of paragraphs B1-B6, further comprising heating (562) the liquid stored in the compartment of the wing (108) to inhibit freezing of the liquid.
B8. The method (550) of any one of paragraphs B1-B7, wherein no fuel is stored in the wing (108) of the aircraft (100).
B9. The method (550) of any one of paragraphs B1-B3 and B5-B8, wherein the fuel comprises one or more of the following: hydrogen, methane/natural gas, propane, butane, ammonia.
B10. An aircraft (100) configured to be operated according to the method (550) of any one of paragraphs B1-B9.
C1. A method (600) for operating an aircraft (100), the method (600) comprising:
operating (604) one or more turbines (116) of the aircraft (100) using a fuel supplied to the one or more turbines (116) from a fuel supply (120) disposed in a fuselage (104) of the aircraft (100); and
managing (612) inertial load on a wing (108) of the aircraft (100) by selectively ejecting a liquid from a compartment (124) of the wing (108).
C2. The method (600) of paragraph C1, wherein selectively ejecting the liquid includes selectively injecting the liquid into at least one of the one or more turbines (116).
C3. The method (600) of paragraph C2, wherein the fuel comprises hydrogen and the liquid comprises water.
C4. The method (600) of paragraph C1, wherein selectively ejecting the liquid includes selectively expelling the liquid to an exterior of the aircraft (100).
C5. The method (600) of any one of paragraphs C1-C4, further comprising retaining (608) the liquid in a liquid phase within the compartment (124) by transferring heat to the (124) compartment using a heating assembly (132) at least partially disposed at the wing (108).
C6. The method (600) of any one of paragraphs C1-C5, wherein the fuel is a cryogenic and/or pressurized fuel comprising one or more of the following: hydrogen, methane/natural gas, propane, butane, ammonia.
C7. The method (600) of any one of paragraphs C1-C6, wherein the (124) compartment is an interior compartment (124) formed integrally within the wing (108).
C8. An aircraft (100) configured to be operated according to the method (600) of any one of paragraphs C1-C7.
D1. An aircraft (100) comprising:
a fuselage (104);
a wing (108) extending from a lateral portion of the fuselage (104), the wing (108) including a tank (124) configured to store a liquid other than fuel;
a turbine (116) attached to the wing (108);
an injection assembly (128) configured to inject liquid from the tank (124) into the turbine (116); and
at least a first fuel container (120) coupled to a fuel system (112) configured to provide fuel from the at least first fuel container (120) to the turbine, wherein the first fuel container (120) is disposed inboard of the wing (108).
D2. The aircraft (100) of paragraph D1, wherein the tank (124) is integrally defined within the wing (108).
D3. The aircraft (100) of paragraph D2, wherein the tank (124) includes a plurality of compartments inside the wing (108).
D4. The aircraft (100) of paragraph D2, wherein the tank (124) is a first tank (124) and the wing (108) further includes at least a second tank (124).
D5. The aircraft of any one of paragraphs D1-D4, wherein the first fuel container (120) is disposed at the fuselage (104).
D6. The aircraft (100) of paragraph D5, wherein the first fuel container (120) is contained within the fuselage (104).
D7. The aircraft (100) of any one of paragraphs D1-D6, wherein the liquid comprises water.
D8. The aircraft (100) of any one of paragraphs D1-D7, wherein the first fuel container (120) is configured to store fuel in a pressurized state.
D9. The aircraft (100) of any one of paragraphs D1-D8, wherein the turbine (116) is configured to operate using a cryogenic and/or pressurized fuel and the first fuel container (120) is configured to store the cryogenic and/or pressurized fuel in a liquid phase.
D10. The aircraft (100) of any one of paragraphs D1-D8, wherein the turbine (116) is configured to operate using either natural gas or jet fuel as fuel, the aircraft (100) further comprising a second fuel container (120) configured to store jet fuel.
D11. The aircraft (100) of any one of paragraphs D1-D10, wherein the wing (108) further includes a heat system (132) configured to provide heat to the tank (124).
D12. The aircraft (100) of paragraph D11, wherein the heat system (132) is configured to provide heat to the tank (124) by transferring heat from the turbine (116) to the tank (124).
D13. The aircraft (100) of any one of paragraphs D1-D12, wherein the injection assembly (128) is configured to inject liquid into a compressor of the turbine (116).
D14. The aircraft (100) of any one of paragraphs D1-D12, wherein the injection assembly (128) is configured to inject liquid into a combustor of the turbine (116).
D15. The aircraft (100) of any one of paragraphs D1-D12, wherein the injection assembly is configured to inject liquid into a fuel line of the turbine.
D16. The aircraft (100) of any one of paragraphs D1-D15, wherein the wing (108) is free of any fuel containers (120).
D17. The aircraft (100) of any one of paragraphs D1-D15, further comprising a fuel pod (316) attached to the wing (108).
D18. The aircraft (100) of paragraph D17, wherein the fuel pod (316) is configured to store a cryogenic fuel in a liquid phase.
D19. The aircraft (100) of any one of paragraphs D1-D18, wherein the wing (108) is a first wing (108) and the turbine (116) is a first turbine (116), the aircraft (100) further comprising a second wing (108) and a second turbine (116) attached to the second wing (108).
D20. The aircraft (100) of any one of paragraphs D1-D19, wherein the aircraft (100) is an airliner.
D21. The aircraft (100) of any one of paragraphs D1-D20, further comprising a cryogenic fuel cell (354) configured to provide power to a first system (358) of the aircraft (100), and a wastewater collection assembly (362) configured to provide wastewater generated by the cryogenic fuel cell (354) to a second system (364) of the aircraft (100).
D22. The aircraft (100) of paragraph D21, wherein the first system (358) of the aircraft (100) is an auxiliary power system.
D23. The aircraft (100) of any one of paragraphs D21-D22, wherein the second system (364) of the aircraft (100) is a propulsion system including the turbine (116), and the wastewater collection assembly (362) is configured to provide the wastewater to the turbine (116).
E1. An aircraft (100) comprising:
a fuselage (104);
a wing (108) attached to the fuselage (104);
an engine (116) attached to the wing (108); and
a fuel tank (120) disposed in the fuselage (104) and in fluid communication with the engine (116);
wherein the wing (108) includes an integral interior compartment (124) configured to contain a nonfuel liquid, and a liquid transfer assembly (128) configured to selectively expel nonfuel liquid from the integral interior compartment (124).
E2. The aircraft (100) of paragraph E1, wherein the liquid transfer assembly (128) is configured to inject nonfuel liquid from the integral interior compartment (124) to the engine (116).
E3. The aircraft (100) of any one of paragraphs E1-E2, wherein the integral interior compartment (124) comprises a plurality of subcompartments.
E4. The aircraft (100) of any one of paragraph E1-E3, wherein the integral interior compartment (124) is a first integral interior compartment (124), the wing (108) further including a second integral interior compartment (124) spaced from the first integral interior compartment (124).
E5. The aircraft (100) of any one of paragraphs E1-E4, further comprising a heating assembly (132) configured to heat the integral interior compartment (124).
E6. The aircraft (100) of paragraph E5, wherein the heating assembly (132) is configured to heat the integral interior compartment (124) using heat from the engine (116).
E7. The aircraft (100) of any one of paragraphs E1-E6, wherein the fuel tank (120) is configured to store a pressurized and/or cryogenic fuel in a liquid phase.
E8. The aircraft (100) of paragraph E7, wherein the pressurized and/or cryogenic fuel comprises one or more of the following: hydrogen, methane/natural gas, propane, butane, ammonia.
E9. The aircraft (100) of paragraph E7, wherein the fuel tank (120) is configured to store hydrogen in a liquid phase and the engine (116) comprises a hydrogen-burning turbine.
E10. The aircraft (100) of any one of paragraphs E1-E9, wherein the wing (108) is a first wing (108) extending from a first lateral side of the aircraft (100), the aircraft (100) further comprising a second wing (108) extending from a second lateral side of the aircraft (100).
E11. The aircraft (100) of any one of paragraphs E1-E10, wherein the aircraft (100) comprises an airliner.
E12. The aircraft (100) of any one of paragraphs E1-E11, wherein the wing (108) is free of any fuel tanks (120).
E13. The aircraft (100) of any one of paragraphs E1-E12, further comprising a fuel cell (354) in fluid communication with the engine (116), such that wastewater generated by the fuel cell (354) is transferred to the engine (116).
E14. The aircraft (100) of paragraph E13, wherein the fuel cell (354) is a cryogenic fuel cell.
E15. The aircraft (100) of any one of paragraphs E13-E14, wherein the fuel cell (354) is operatively coupled to an auxiliary power unit of the aircraft (100).
F1. An aircraft (100) comprising:
a fuselage (104);
a wing (108) extending from the fuselage (104);
a hydrogen-burning gas turbine (116) attached to the wing (108);
a hydrogen fuel cell (354) configured to provide auxiliary power to the aircraft (100); and
a wastewater collection system (362) configured to transfer wastewater produced by the hydrogen fuel cell (354) into the hydrogen-burning gas turbine (116).
F2. The aircraft (100) of paragraph F1, wherein the wing (108) is a first wing (108) extending from the fuselage (104) in a first direction, the aircraft (100) further comprising a second wing (108) extending from the fuselage (104) in a second direction opposite the first direction.
F3. The aircraft (100) of any one of paragraphs F1-F2, wherein the aircraft (100) is an airliner.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method for operating an aircraft using a cryogenic and/or pressurized fuel with reduced NOx emissions, the method comprising:
operating one or more engines of the aircraft using the fuel, thereby reducing a mass of the fuel carried with the aircraft; and
based on a reduction in the mass of the fuel carried with the aircraft, injecting a liquid comprising water into the one or more engines from a storage tank contained within a wing of the aircraft.

2. The method of claim 1, wherein the fuel is carried with the aircraft in one or more fuel containers disposed in a fuselage of the aircraft, the method further comprising supplying the fuel to the one or more engines from the one or more fuel containers.

3. The method of claim 2, wherein the one or more fuel containers include a first fuel container disposed in a first area of the fuselage and a second fuel container disposed in a second area of the fuselage, the first area being aft of the second area.

4. The method of claim 1, wherein the storage tank is incorporated integrally into an interior of the wing.

5. The method of claim 1, further comprising inhibiting freezing of the liquid by providing heat to the storage tank using a heat system disposed at least partially within the wing.

6. The method of claim 1, wherein the liquid further comprises a substance configured to lower a freezing temperature of the liquid to a temperature below a freezing temperature of water.

7. The method of claim 1, wherein the fuel comprises one or more of: hydrogen, natural gas, propane, butane, ammonia.

8. An aircraft comprising:
a fuselage;
a wing extending from a lateral portion of the fuselage, the wing including a tank configured to store a liquid other than fuel;
a turbine attached to the wing;
an injection assembly configured to inject the liquid from the tank into the turbine;
at least a first fuel container coupled to a fuel system configured to provide fuel from the at least first fuel container to the turbine, wherein the first fuel container is disposed inboard of the wing; and
a controller configured to control the injection assembly to inject the liquid from the tank into the turbine at least partially automatically based on a reduction in fuel stored in the at least first fuel container.

9. The aircraft of claim 8, wherein the tank is integrally defined within the wing.

10. The aircraft of claim 9, wherein the tank includes one or more baffles.

11. The aircraft of claim 8, wherein the first fuel container is disposed at the fuselage.

12. The aircraft of claim 11, wherein the first fuel container is contained within the fuselage.

13. The aircraft of claim 8, wherein the turbine is configured to operate using a cryogenic fuel and the first fuel container is configured to store the cryogenic fuel in a liquid phase.

14. The aircraft of claim 8, wherein the wing further includes a heat system configured to provide heat to the tank by transferring heat from the turbine to the tank.

15. An aircraft comprising:
a fuselage;
a wing attached to the fuselage;
an engine attached to the wing; and
a fuel tank disposed in the fuselage and in fluid communication with the engine;
wherein the wing includes an integral interior compartment configured to contain a nonfuel liquid, and a liquid transfer assembly configured to selectively expel the nonfuel liquid from the integral interior compartment, wherein the liquid transfer assembly includes a controller configured to selectively expel the nonfuel liquid from the integral interior compartment at least partially automatically based on a reduction in fuel in the fuel tank.

16. The aircraft of claim 15, wherein the liquid transfer assembly is configured to inject the nonfuel liquid from the integral interior compartment to the engine.

17. The aircraft of claim 15, wherein the integral interior compartment comprises a plurality of subcompartments.

18. The aircraft of claim 15, wherein the fuel tank is configured to store a pressurized and/or cryogenic fuel in a liquid phase.

19. The aircraft of claim 18, wherein the pressurized and/or cryogenic fuel comprises at least one of: hydrogen, methane, propane, butane, ammonia.

20. The aircraft of claim 15, wherein the fuel tank is configured to store hydrogen in a liquid phase and the engine comprises a hydrogen-burning turbine.
